(19) United States
(12) Patent Application Publication
(10) Pub. No.: US 2026/0273440 A1
(43) Pub. Date: Sep. 17, 2026

(54) METHOD FOR MANUFACTURING FILTER UNIT

(71) Applicant: SEIKO EPSON CORPORATION, TOKYO (JP)

(72) Inventors: Masahiro KARASAWA, MATSUMOTO-SHI (JP); Keita ICHIHARA, SHIOJIRI-SHI (JP)

(21) Appl. No.: 19/563,151

(22) Filed: Mar. 11, 2026

(30) Foreign Application Priority Data
Mar. 12, 2025 (JP) 2025-039105

(51) Int. Cl. B01D 29/01; B01D 39/16

(52) U.S. Cl. CPC B01D 29/012; B01D 39/16

(57) ABSTRACT

A method for manufacturing a filter unit includes: a first setting step of setting a filter portion in a setting portion provided in a first base portion; a welding step of welding the filter portion set on the setting portion and the first base portion by bringing a first heater unit into contact with a protruding portion provided in the first base portion to melt the protruding portion; and a separating step of separating the first heater unit from the filter portion, the protruding portion before being melted protrudes from the filter portion set on the setting portion in a first direction orthogonal to a surface of the filter portion, and in the filter portion before being welded, a positioning portion provided at an end portion is in contact with the setting portion, and a part of the filter portion protrudes from the positioning portion in a second direction opposite to the first direction.

The present application is based on, and claims priority from JP Application Serial Number 2025-039105, filed Mar. 12, 2025, the disclosure of which is hereby incorporated by reference herein in its entirety.

### BACKGROUND

### 1. Technical Field

The present disclosure relates to a method for manufacturing a filter unit.

### 2. Related Art

For example, as in JP-A-2008-023820, there is a filter fixing method that is an example of a method for manufacturing a filter unit. When a filter that is an example of a filter portion is fixed, the filter is placed inside a welding wall that is an example of a protruding portion. A thermal welding jig deforms the welding wall by applying heat and a load thereto. The deformed welding wall covers an upper surface of the filter to fix the filter to a supply cylinder.

JP-A-2008-023820 is an example of the related art.

The filter of JP-A-2008-023820 is fixed after being set on a triangular protrusion. Therefore, for example, when a filter having low rigidity is set, the filter may not be appropriately fixed due to bending or deviation.

### SUMMARY

A method for manufacturing a filter unit that solves the above problem is a method for manufacturing a filter unit for removing foreign matter in a liquid supplied to a liquid ejection head configured to eject the liquid, the method including: a first setting step of setting a filter portion in a setting portion provided in a first base portion; a welding step of welding the filter portion set on the setting portion and the first base portion by bringing a first heater unit into contact with a protruding portion provided in the first base portion to melt the protruding portion; and a separating step of separating the first heater unit from the filter portion, in which the protruding portion before being melted protrudes from the filter portion set on the setting portion in a first direction orthogonal to a surface of the filter portion, and in the filter portion before being set on the setting portion and welded, a positioning portion provided at an end portion is in contact with the setting portion, and a part of the filter portion protrudes from the positioning portion in a second direction opposite to the first direction.

### BRIEF DESCRIPTION OF THE DRAWINGS

FIG. 1 is a schematic diagram of a liquid ejection apparatus.

FIG. 2 is a schematic cross-sectional view along an arrowed line 2-2 in FIG. 1.

FIG. 3 is an exploded perspective view of a filter manufacturing apparatus.

FIG. 4 is a schematic cross-sectional view illustrating a second setting step of the filter manufacturing apparatus.

FIG. 5 is a schematic cross-sectional view illustrating a cutting step of the filter manufacturing apparatus.

FIG. 6 is a schematic cross-sectional view illustrating a removal step of the filter manufacturing apparatus.

FIG. 7 is a schematic cross-sectional view of a unit manufacturing apparatus.

FIG. 8 is a schematic cross-sectional view illustrating a first setting step of the unit manufacturing apparatus.

FIG. 9 is a schematic cross-sectional view illustrating a welding step of the unit manufacturing apparatus.

FIG. 10 is a schematic cross-sectional view illustrating a separating step of the unit manufacturing apparatus.

### DESCRIPTION OF EMBODIMENTS

### Embodiment

Hereinafter, an embodiment of a method for manufacturing a filter unit will be described with reference to the drawings. The filter unit is attached to, for example, a liquid ejection apparatus. The liquid ejection apparatus is, for example, an inkjet printer that performs printing by ejecting ink, which is an example of a liquid, onto a medium such as a sheet.

In the drawings, the direction of gravity is indicated by a Z axis, and directions along a horizontal plane are indicated by an X axis and a Y axis. The X axis, the Y axis, and the Z axis are perpendicular to each other. In the following description, a direction parallel to the Z axis is also referred to as a vertical direction Z.

### Liquid Ejection Apparatus

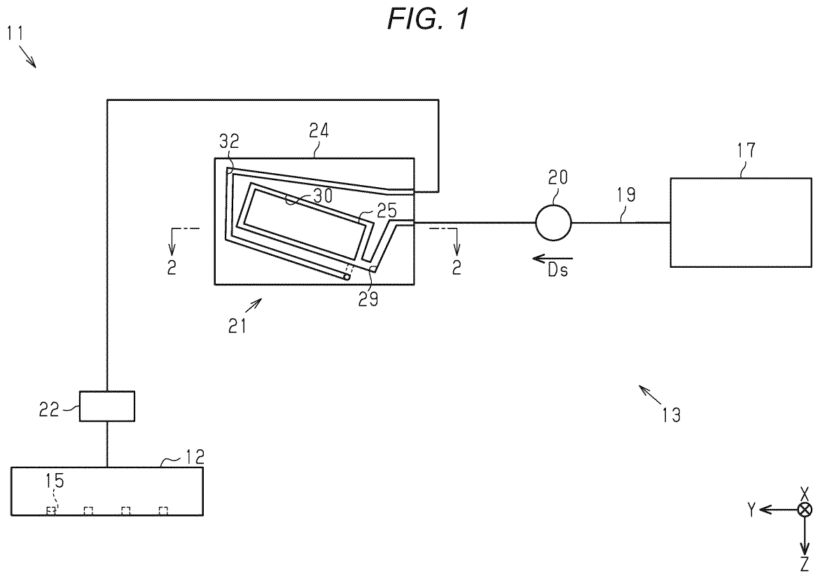

As illustrated in FIG. 1, a liquid ejection apparatus 11 includes a liquid ejection head 12 and a liquid supply apparatus 13.

The liquid ejection head 12 can eject a liquid. The liquid ejection head 12 includes one or more nozzles 15. The liquid ejection head 12 ejects the liquid from the nozzles 15 to perform printing on a medium (not illustrated).

### Liquid Supply Apparatus

The liquid supply apparatus 13 can be connected to the liquid ejection head 12. The liquid supply apparatus 13 supplies the liquid from a liquid container 17 containing liquid to the liquid ejection head 12.

The liquid supply apparatus 13 may include a supply flow path 19, a supply pump 20, a filter unit 21, and a pressure regulating mechanism 22.

An upstream end of the supply flow path 19 is connected to the liquid container 17. A downstream end of the supply flow path 19 is connected to the liquid ejection head 12. The supply flow path 19 supplies the liquid to the liquid ejection head 12. The liquid flows through the supply flow path 19 in a supply direction Ds.

The supply pump 20 applies a negative pressure to the liquid contained in the liquid container 17. The supply pump 20 leads out the liquid from the liquid container 17 to the supply flow path 19. The supply pump 20 pressurizes the led-out liquid to supply the liquid to the liquid ejection head 12.

The pressure regulating mechanism 22 can regulate the pressure in the liquid ejection head 12. The pressure regulating mechanism 22 is provided in the supply flow path 19 downstream of the filter unit 21. The pressure regulating mechanism 22 stabilizes the pressure of the liquid that is supplied to the nozzles 15 by regulating the pressure of the liquid pressurized and supplied. The pressure regulating mechanism 22 regulates the pressure of the liquid in the liquid ejection head 12 into pressure at which a meniscus is formed in the nozzle 15. The pressure regulating mechanism 22 opens the supply flow path 19 when downstream pressure is lower than predetermined pressure. For example, when the liquid is ejected from the nozzles 15 or the liquid is discharged from the nozzles 15, the liquid in the liquid ejection head 12 decreases and the pressure of the liquid decreases. When downstream negative pressure increases, the pressure regulating mechanism 22 opens the supply flow path 19 to supply the liquid to the liquid ejection head 12.

### Filter Unit

The filter unit 21 is provided in the supply flow path 19. The filter unit 21 removes foreign matter from the liquid supplied to the liquid ejection head 12.

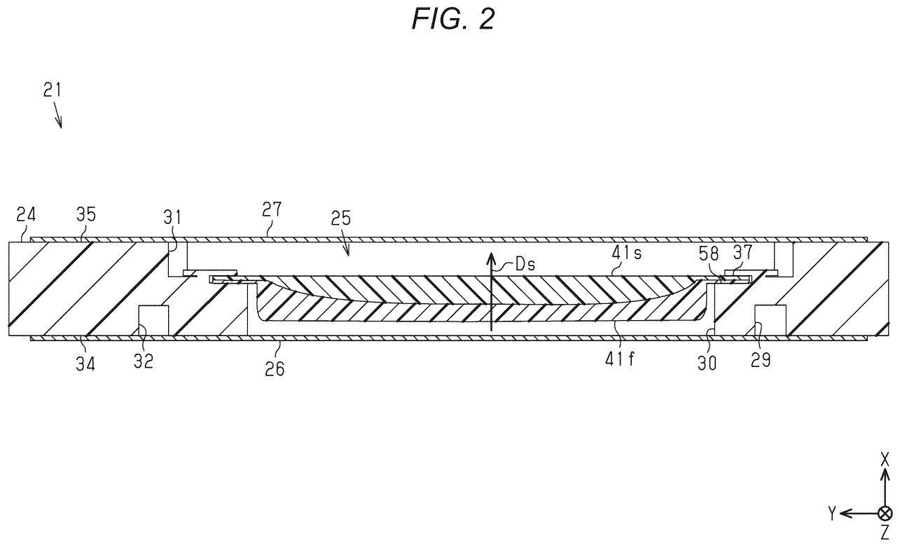

As illustrated in FIG. 2, the filter unit 21 may include a first base portion 24, a filter portion 25, a first covering portion 26, and a second covering portion 27. The filter unit 21 may include an introduction flow path 29, a pre-chamber 30, a post-chamber 31, and a lead-out flow path 32.

The first base portion 24 may be formed of a resin such as polypropylene. The first base portion 24 has a first surface 34 and a second surface 35. The first surface 34 is a surface opposite to the second surface 35.

The filter portion 25 is for collecting foreign matter. The filter portion 25 may be formed of the same material as the first base portion 24. The filter portion 25 may be formed of a resin. The filter portion 25 is fixed to the first base portion 24. The filter portion 25 partitions the pre-chamber 30 and the post-chamber 31. The filter portion 25 includes a positioning portion 37. The positioning portion 37 is formed in an annular shape along the edge of the filter portion 25.

The first covering portion 26 and the second covering portion 27 may be flexible films or hard lids. The first covering portion 26 and the second covering portion 27 are attached to the first base portion 24.

The first covering portion 26 may be welded to the first surface 34. The first covering portion 26 may form the introduction flow path 29 and the lead-out flow path 32 by closing each of a plurality of grooves formed in the first surface 34. The first covering portion 26 may form the pre-chamber 30 between the first covering portion 26 and the filter portion 25 by closing a hole opened in the first surface 34.

The second covering portion 27 may be welded to the second surface 35. The second covering portion 27 may form the post-chamber 31 between the second covering portion 27 and the filter portion 25 by closing a hole opened in the second surface 35.

The introduction flow path 29 connects the supply flow path 19 on an upstream side and the pre-chamber 30. The lead-out flow path 32 connects the post-chamber 31 and the supply flow path 19 on the downstream side. The introduction flow path 29 sends the liquid introduced from the supply flow path 19 to the pre-chamber 30. The liquid sent to the pre-chamber 30 passes through the filter portion 25 and moves to the post-chamber 31. The lead-out flow path 32 sends the liquid passing through the filter portion 25 to the supply flow path 19. Therefore, the supply direction Ds of the liquid in the filter unit 21 is a direction in which the liquid flows in the order of the introduction flow path 29, the pre-chamber 30, the post-chamber 31, and the lead-out flow path 32.

### Filter Manufacturing Apparatus

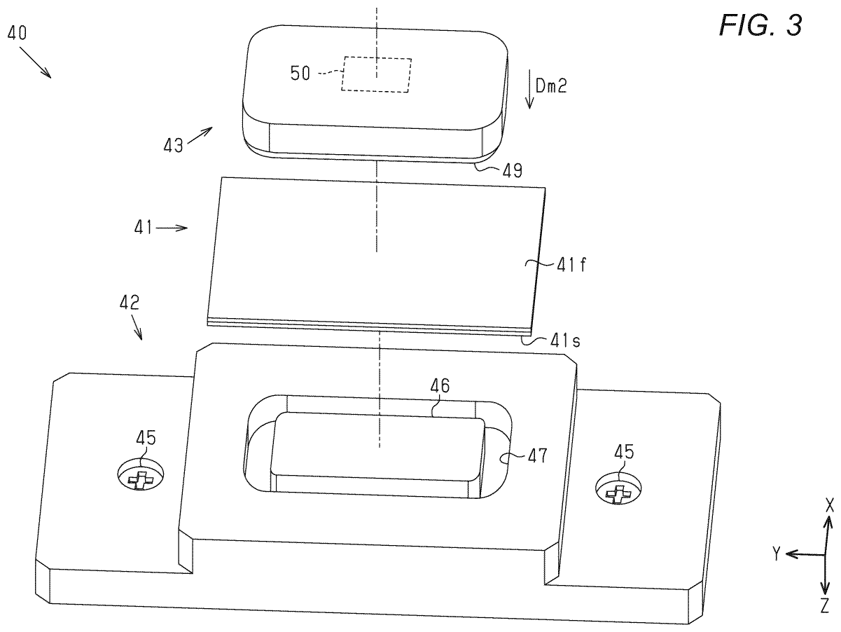

As illustrated in FIG. 3, the filter manufacturing apparatus 40 manufactures the filter portion 25 from a filter material 41. The filter manufacturing apparatus 40 may include a second base portion 42 and a second heater unit 43.

The second base portion 42 may be fixed to a base (not illustrated) by one or more screws 45. The second base portion 42 may include a pedestal 46 and a cut groove 47. The cut groove 47 is formed in an annular shape so as to surround the pedestal 46.

The second heater unit 43 includes a cutting portion 49 and a heating unit 50. The second heater unit 43 is provided to be movable relative to the second base portion 42. The second heater unit 43 may be capable of reciprocating in a second movement direction Dm2. The second movement direction Dm2 may be the same direction as the vertical direction Z.

The heating unit 50 heats the cutting portion 49. The heating unit 50 heats the cutting portion 49 to a temperature higher than a melting temperature of the filter material 41.

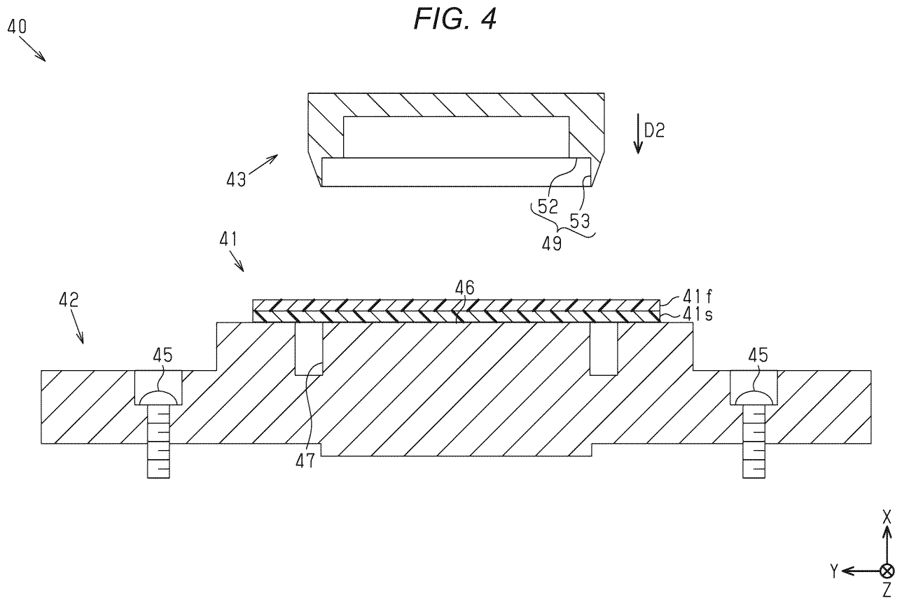

As illustrated in FIG. 4, the cutting portion 49 may include a pressing portion 52 and a blade portion 53.

The pressing portion 52 is formed in an annular shape inside the blade portion 53. The pressing portion 52 may be located on the pedestal 46. The pressing portion 52 may have a surface parallel to a surface on which the pedestal 46 supports the filter material 41. In a state where the filter material 41 is not set on the second base portion 42, the pressing portion 52 may face the pedestal 46 in the second movement direction Dm2.

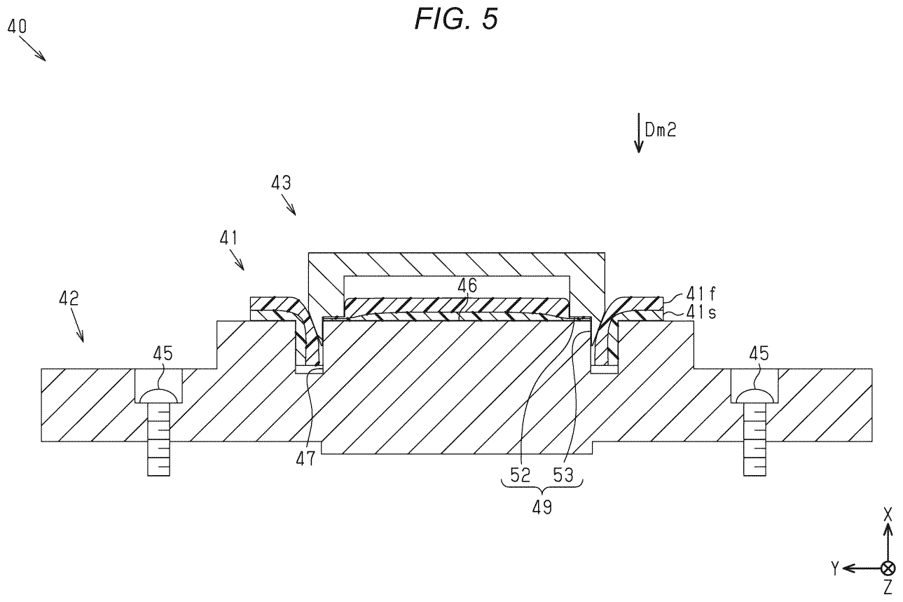

As illustrated in FIG. 5, the blade portion 53 is annularly provided along the edge of the pedestal 46. The blade portion 53 protrudes in the second movement direction Dm2 more than the pressing portion 52. In a state where the filter material 41 is not set on the second base portion 42, the blade portion 53 may face the cut groove 47 in the second movement direction Dm2.

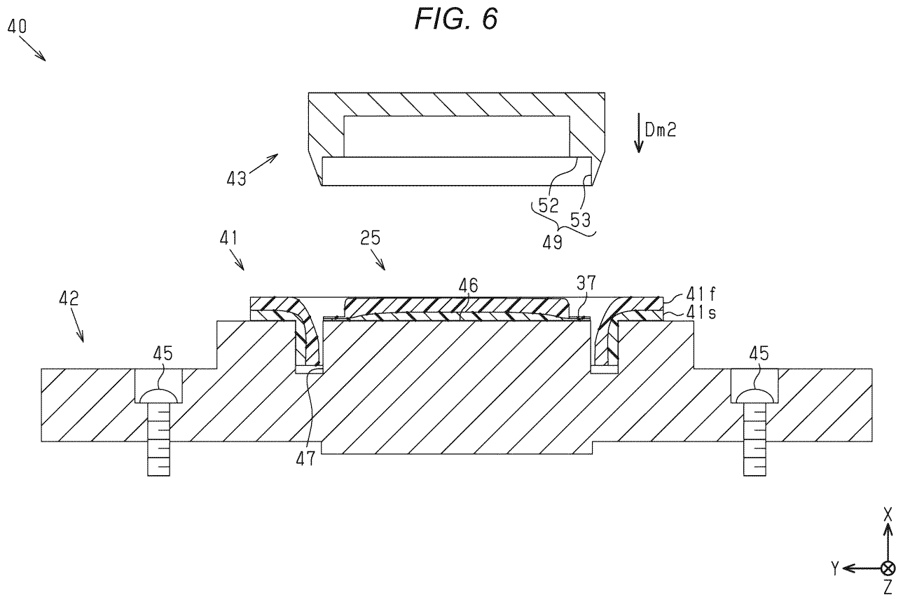

As illustrated in FIG. 6, the blade portion 53 is allowed to move in the second movement direction Dm2 from the pedestal 46 by the cut groove 47. The blade portion 53 can cut the filter material 41 by sandwiching the filter material 41 between the blade portion 53 and the pedestal 46.

### Method for Processing Filter Material

A method for processing the filter material 41 may include a second setting step, a cutting step, and a removal step. The second setting step, the cutting step, and the removal step are executed in this order.

### Second Setting Step

As illustrated in FIG. 4, in the second setting step, the filter material 41 is set on the second base portion 42. The filter material 41 is larger than the pedestal 46. The filter material 41 is placed on the pedestal 46 such that all ends thereof are located outside the pedestal 46. The filter material 41 may be larger than the cut groove 47.

A plurality of filter materials 41 may be stacked and set on the second base portion 42. The plurality of filter materials 41 may have different mesh sizes. In the embodiment, of the two types of filter materials 41 having different mesh sizes, the filter material 41 having a coarse mesh is also referred to as a first filter material 41f, and the filter material 41 having a finer mesh than the first filter material 41f is also referred to as a second filter material 41s.

The first filter material 41f and the second filter material 41s are stacked and set on the second base portion 42. At this time, the first filter material 41f and the second filter material 41s stacked in advance may be placed on the second base portion 42. The first filter material 41f and the second filter material 41s may be sequentially placed on the second base portion 42 one by one and stacked on the second base portion 42.

The first filter material 41f set on the second base portion 42 is located on the second filter material 41s. That is, the second filter material 41s is located below the first filter material 41f and is in contact with the pedestal 46.

### Cutting Step

As illustrated in FIG. 5, in the cutting step, the positioning portion 37 is formed by compressing and melting an end portion of the filter material 41 while cutting the filter material 41 set on the second base portion 42 by the second heater unit 43.

In the cutting step, the second heater unit 43 moves in the second movement direction Dm2. The second heater unit 43 approaches the second base portion 42. In the second heater unit 43, the blade portion 53 cuts the filter material 41, and the pressing portion 52 presses the filter material 41 against the pedestal 46. A portion sandwiched between the pressing portion 52 and the pedestal 46 is compressed. The second heater unit 43 is not in contact with a central portion of the filter material 41. Therefore, a portion of the filter material 41 located at the center of the pedestal 46 is less likely to be compressed and the thickness thereof is easily maintained.

The blade portion 53 cuts the filter material 41 into the filter portion 25 inside and an offcut outside. The blade portion 53 may cut the filter material 41 by pushing the offcut into the cut groove 47.

The blade portion 53 and the pressing portion 52 are heated to a temperature higher than the melting temperature of the filter material 41. Therefore, a cut surface and a compressed peripheral portion of the filter material 41 are melted by receiving the heat of the cutting portion 49. The first filter material 41f and the second filter material 41s are melted and receive a pressurizing force in an overlapping direction, and thus are bonded.

### Removal Step

As illustrated in FIG. 6, in the removal step, the filter portion 25 is removed from the second base portion 42.

In the removal step, the second heater unit 43 moves in a direction opposite to the second movement direction Dm2. The second heater unit 43 is separated from the second base portion 42. The filter portion 25 and the offcut remain in the second base portion 42 or move together with the second heater unit 43. After the second heater unit 43 moves, the filter portion 25 and the offcut are removed from the second base portion 42 or the second heater unit 43.

When the second heater unit 43 is separated from the filter portion 25, a melted portion is cooled and solidified in a compressed shape. The positioning portion 37 of the embodiment is a portion solidified in a compressed shape. The thickness of the positioning portion 37 is smaller than the thickness of a central portion of the filter portion 25. The positioning portion 37 is formed by the first filter material 41f and the second filter material 41s. The first filter material 41f and the second filter material 41s maintain the bonded state.

### Unit Manufacturing Apparatus

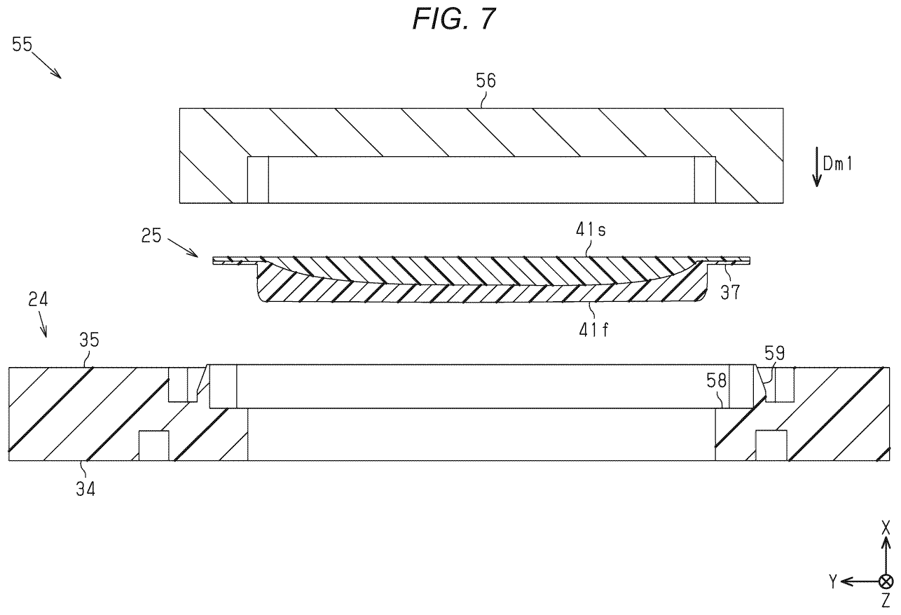

As illustrated in FIG. 7, the unit manufacturing apparatus 55 manufactures the filter unit 21 using the filter portion 25. The unit manufacturing apparatus 55 includes a first heater unit 56. The first heater unit 56 fixes the filter portion 25 to the first base portion 24. In the first heater unit 56, an annular portion along the edge protrudes downward from a central portion thereof. The first heater unit 56 can increase the temperature to a temperature higher than a melting temperature of the first base portion 24. The first heater unit 56 is provided to be movable relative to the supported first base portion 24. The first heater unit 56 may be capable of reciprocating in the first movement direction Dm1. The first movement direction Dm1 may be the same direction as the vertical direction Z.

### Method for Assembling Filter Unit

A method for assembling the filter unit 21 may include a first setting step, a welding step, a separating step, and a sealing step.

### First Setting Step

As illustrated in FIG. 7, a setting portion 58 and a protruding portion 59 are provided on the first base portion 24 before the filter portion 25 is attached.

The setting portion 58 is a surface on which the filter portion 25 is set when the filter portion 25 is attached to the first base portion 24. The setting portion 58 may be a horizontal surface. The setting portion 58 may be provided in an annular shape.

The protruding portion 59 may be provided in an annular shape around the setting portion 58. The diameter of the protruding portion 59 is larger than the diameter of the filter portion 25.

An inner surface of the protruding portion 59 may be perpendicular to the setting portion 58. An outer surface of the protruding portion 59 may be inclined with respect to the inner surface thereof. The thickness of the protruding portion 59 may be larger on a base end side close to the setting portion 58 and may decrease toward a tip end.

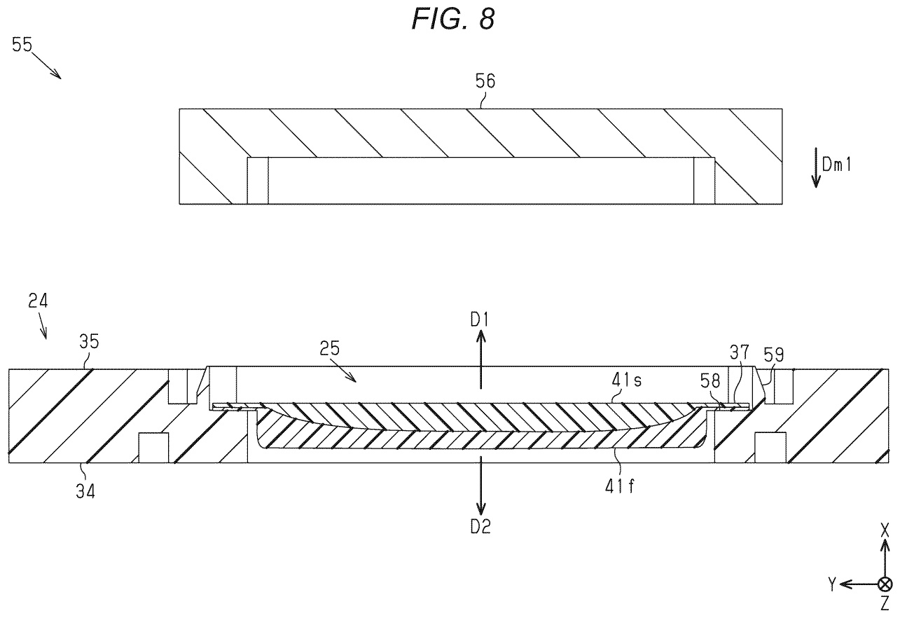

As illustrated in FIG. 8, in the first setting step, the filter portion 25 is set on the setting portion 58. The filter portion 25 is accommodated inside the protruding portion 59 such that the positioning portion 37 is placed on the setting portion 58. At this time, the filter portion 25 may be set such that the first filter material 41f is located below the second filter material 41s.

The protruding portion 59 before being melted protrudes in the first direction D1 orthogonal to a surface of the filter portion 25 more than the filter portion 25 set on the setting portion 58. In the filter portion 25 before being set on the setting portion 58 and welded, the positioning portion 37 provided at an end portion is in contact with the setting portion 58. A part of the filter portion 25 protrudes from the positioning portion 37 in a second direction D2 opposite to the first direction D1.

### Welding Step

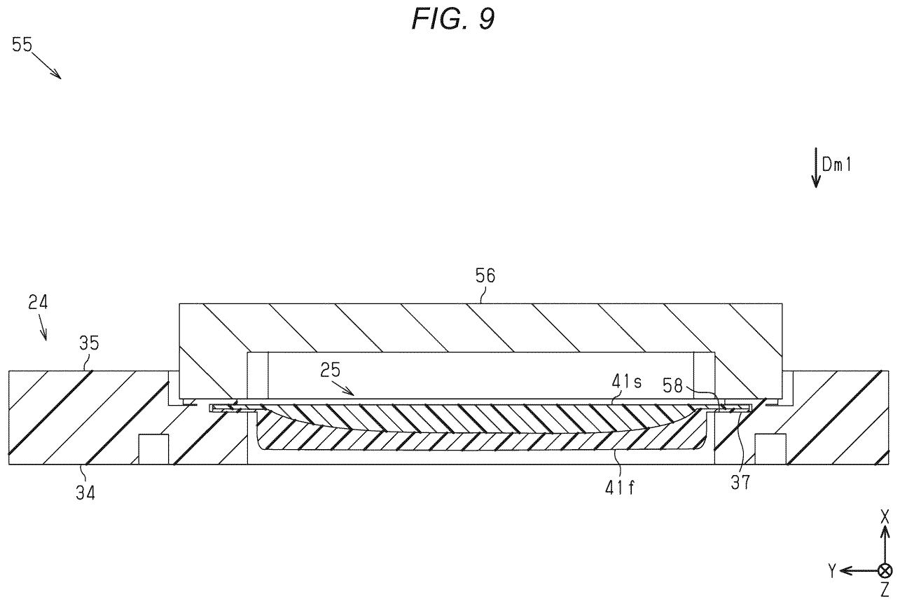

As illustrated in FIG. 9, in the welding step, the first heater unit 56 is brought into contact with the protruding portion 59 to melt the protruding portion 59, and the filter portion 25 set on the setting portion 58 and the first base portion 24 are welded.

In the welding step, the first heater unit 56 moves in the first movement direction Dm1. The first movement direction Dm1 may be the same direction as the second direction D2. The first heater unit 56 approaches the first base portion 24. The first heater unit 56 comes into contact with the tip end of the protruding portion 59 and crushes the protruding portion 59 while melting the protruding portion 59. At this time, the first heater unit 56 is not in contact with the central portion of the filter portion 25. Since the thickness of the tip end of the protruding portion 59 decreases such that the outer surface approaches the inner surface, the crushed protruding portion 59 spreads inward and is easily placed on the filter portion 25.

### Separating Step

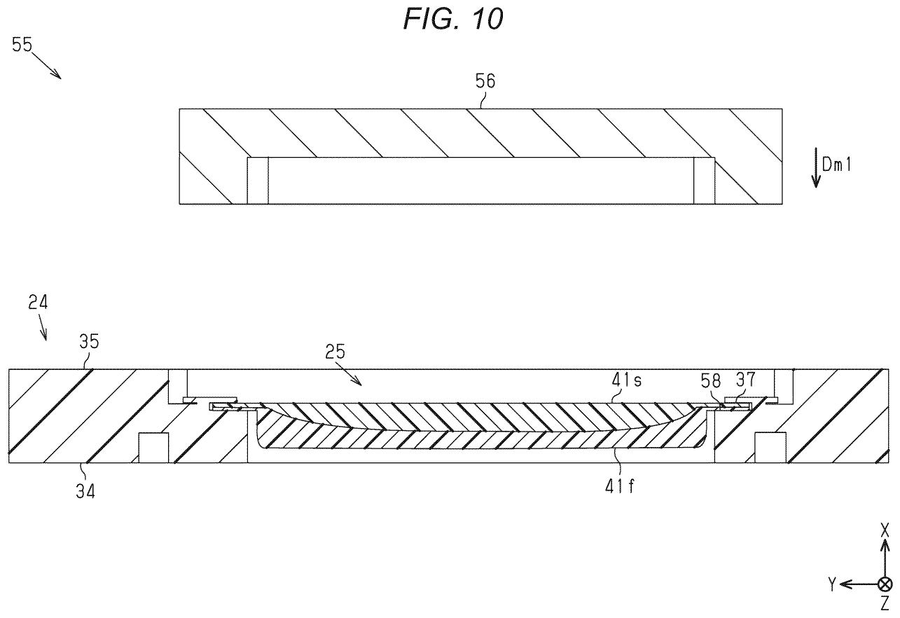

As illustrated in FIG. 10, in the separating step, the first heater unit 56 is separated from the filter portion 25.

In the separating step, the first heater unit 56 moves in a direction opposite to the first movement direction Dm1. The first heater unit 56 is separated from the first base portion 24. When the first heater unit 56 is separated from the first base portion 24, the melted protruding portion 59 is cooled and solidified in a crushed shape. The melted protruding portion 59 and the setting portion 58 fix the filter portion 25 so as to sandwich the positioning portion 37.

### Sealing Step

As illustrated in FIG. 2, in the sealing step, the first covering portion 26 and the second covering portion 27 are attached to the first base portion 24. In the filter portion 25, the first filter material 41f faces the first covering portion 26. The first filter material 41f faces the pre-chamber 30. In the filter portion 25, the second filter material 41s faces the second covering portion 27. The second filter material 41s faces the post-chamber 31.

### Functions of Embodiment

Functions of the embodiment will be described.

The method for manufacturing the filter unit 21 may include the method for processing the filter material 41 and the method for assembling the filter unit 21. That is, the method for manufacturing the filter unit 21 may include the second setting step, the cutting step, the removal step, the first setting step, the welding step, the separating step, and the sealing step. The second setting step, the cutting step, the removal step, the first setting step, the welding step, the separating step, and the sealing step are performed in this order. That is, the second setting step and the cutting step are executed before the first setting step.

### Effects of Embodiment

Effects of the embodiment will be described.

(1-1) The first base portion 24 is provided with the setting portion 58 and the protruding portion 59. The filter portion 25 is set on the setting portion 58 such that the positioning portion 37 is in contact with the setting portion 58 and a part of the filter portion 25 protrudes in the second direction D2. Therefore, since the position of the filter portion 25 with respect to the first base portion 24 can be easily determined, the filter portion 25 can be easily set on the setting portion 58.

(1-2) When the filter material 41 is cut, foreign matter such as fibers or fragments may be generated from the offcut. In this regard, the second heater unit 43 forms the positioning portion 37 by compressing and melting the filter material 41 set on the second base portion 42 while cutting the filter material 41. Therefore, it is possible to manufacture the filter portion 25 in which foreign matter is less likely to be generated and that is easily set on the first base portion 24.

(1-3) When the plurality of filter materials 41 are stacked and cut, the filter materials 41 may be deviated. In this regard, the first filter material 41f and the second filter material 41s set on the second base portion 42 are cut, compressed, and melted together by the second heater unit 43. Therefore, the deviation between the first filter material 41f and the second filter material 41s can be suppressed.

(1-4) In the filter portion 25, the first filter material 41f having a coarse mesh is located below, and the second filter material 41s having a fine mesh is located above. By determining the positions of the first filter material 41f and the second filter material 41s with respect to the first base portion 24, variation in performance of the manufactured filter unit 21 can be reduced.

(1-5) The first heater unit 56 welds the filter portion 25 and the first base portion 24 by melting the protruding portion 59. Therefore, even when the filter portion 25 and the first base portion 24 are formed of a resin and melting points of the filter portion 25 and the first base portion 24 are close to each other, the possibility that the filter portion 25 is detached from the first base portion 24 can be reduced. Therefore, an attachment strength can be ensured.

### Modifications

The embodiment can be implemented with the following modifications. The embodiment and the following modifications can be implemented in combination with each other as long as no technical inconsistencies are involved.

The filter portion 25 and the first base portion 24 may be formed of different materials. The first heater unit 56 may fix the filter portion 25 to the first base portion 24 by causing the melted protruding portion 59 to permeate the filter portion 25.

The filter portion 25 may be set on the first base portion 24 such that the first filter material 41f is located above the second filter material 41s.

In the second setting step, one filter material 41 may be set on the second base portion 42. In the second setting step, the plurality of filter materials 41 having the same mesh size may be stacked and set on the second base portion 42. In the second setting step, a plurality of at least one of the first filter material 41f and the second filter material 41s may be stacked. For example, when the foreign matter contained in the liquid is large, it is possible to reduce an increase in pressure loss when removing the foreign matter in the liquid by manufacturing the filter portion 25 by stacking a plurality of first filter materials 41f and one second filter material 41s. For example, when the foreign matter contained in the liquid is small, the foreign matter can be easily removed by manufacturing the filter portion 25 by stacking one first filter material 41f and a plurality of second filter materials 41s.

In the method for manufacturing the filter unit 21, the separately manufactured filter portion 25 may be attached to the first base portion 24. That is, the method for manufacturing the filter unit 21 may not include the method for processing the filter material 41.

The liquid ejection apparatus 11 can be a liquid ejection apparatus that jets or ejects liquids other than ink. The state of the liquid to be ejected from the liquid ejection apparatus as a minute amount of droplet includes a particle state, a teardrop state, and a state of tailing like a thread. The liquid mentioned here may be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as a liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include the ink described in the above embodiment and a liquid crystal. Here, the term “ink” includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of a transparent resin such as an ultraviolet curable resin onto a substrate in order to form a minute hemispherical lens, an optical lens, or the like, which are used for an optical communication element or the like. The liquid ejection apparatus may be an apparatus that ejects an etching liquid such as acid or alkali in order to etch a substrate or the like.

### Definitions

The expression “at least one” used in the present specification refers to “one or more” of desired options. For example, the expression “at least one” used in the present specification refers to “only one option” or “both of two options” when the number of options is two. As another example, the expression “at least one” used in the present specification means “only one option”, “a combination of any two options”, or “a combination of any three or more options” when the number of options is three or more.

### Appendices

Technical ideas figured out from the embodiment and the modifications described above and action effects thereof are described below.
[1] A method for manufacturing a filter unit is a method for manufacturing a filter unit for removing foreign matter in a liquid supplied to a liquid ejection head configured to eject the liquid, the method including: a first setting step of setting a filter portion in a setting portion provided in a first base portion; a welding step of welding the filter portion set on the setting portion and the first base portion by bringing a first heater unit into contact with a protruding portion provided in the first base portion to melt the protruding portion; and a separating step of separating the first heater unit from the filter portion, in which the protruding portion before being melted protrudes from the filter portion set on the setting portion in a first direction orthogonal to a surface of the filter portion, and in the filter portion before being set on the setting portion and welded, a positioning portion provided at an end portion is in contact with the setting portion, and a part of the filter portion protrudes from the positioning portion in a second direction opposite to the first direction.

According to this method, the first base portion is provided with the setting portion and the protruding portion. The filter portion is set on the setting portion such that the positioning portion is in contact with the setting portion and a part of the filter portion protrudes in the second direction. Therefore, since the position of the filter portion with respect to the first base portion can be easily determined, the filter portion can be easily set on the setting portion.
[2] The method for manufacturing a filter unit according to the above [1] further includes: a second setting step of setting a filter material on a second base portion; and a cutting step of forming the positioning portion by compressing and melting the end portion while cutting the filter material set on the second base portion by a second heater unit including a cutting portion and a heating unit, in which the second setting step and the cutting step may be executed before the first setting step.

When the filter material is cut, foreign matter such as fibers or fragments may be generated from the offcut. In this regard, according to this method, the second heater unit forms the positioning portion by compressing and melting the filter material set on the second base portion while cutting the filter material. Therefore, it is possible to manufacture the filter portion in which foreign matter is less likely to be generated and that is easily set on the first base portion. [3] In the method for manufacturing a filter unit according to the above [1] or [2], when the filter material is a first filter material, in the second setting step, the first filter material and a second filter material having a finer mesh than the first filter material may be stacked and set on the second base portion.

When the plurality of filter materials are stacked and cut, the filter materials may be deviated. In this regard, according to this method, the first filter material and the second filter material set on the second base portion are cut, compressed, and melted together by the second heater unit. Therefore, the deviation between the first filter material and the second filter material can be suppressed.
[4] In the method for manufacturing a filter unit according to the above [3], in the first setting step, the filter portion may be set such that the first filter material is located below the second filter material.

According to this method, in the filter portion, the first filter material having a coarse mesh is located below, and the second filter material having a fine mesh is located above. By determining the positions of the first filter material and the second filter material with respect to the first base portion, variation in performance of the manufactured filter unit can be reduced.
[5] In the method for manufacturing a filter unit according to any one of the above [1] to [4], the filter portion and the first base portion may be formed of a resin.

According to this method, the first heater unit welds the filter portion and the first base portion by melting the protruding portion. Therefore, even when the filter portion and the first base portion are formed of a resin and melting points of the filter portion and the first base portion are close to each other, the possibility that the filter portion is detached from the first base portion can be reduced. Therefore, an attachment strength can be ensured.

What is claimed is:

1. A method for manufacturing a filter unit for removing foreign matter in a liquid supplied to a liquid ejection head configured to eject the liquid, the method comprising:
a first setting step of setting a filter portion in a setting portion provided in a first base portion;
a welding step of welding the filter portion set on the setting portion and the first base portion by bringing a first heater unit into contact with a protruding portion provided in the first base portion to melt the protruding portion; and
a separating step of separating the first heater unit from the filter portion, wherein
the protruding portion before being melted protrudes from the filter portion set on the setting portion in a first direction orthogonal to a surface of the filter portion, and
in the filter portion before being set on the setting portion and welded, a positioning portion provided at an end portion is in contact with the setting portion, and a part of the filter portion protrudes from the positioning portion in a second direction opposite to the first direction.

2. The method for manufacturing a filter unit according to claim 1, further comprising:
a second setting step of setting a filter material on a second base portion; and
a cutting step of forming the positioning portion by compressing and melting the end portion while cutting the filter material set on the second base portion by a second heater unit including a cutting portion and a heating unit, wherein
the second setting step and the cutting step are executed before the first setting step.

3. The method for manufacturing a filter unit according to claim 2, wherein
when the filter material is a first filter material,
in the second setting step, the first filter material and a second filter material having a finer mesh than the first filter material are stacked and set on the second base portion.

4. The method for manufacturing a filter unit according to claim 3, wherein
in the first setting step, the filter portion is set such that the first filter material is located below the second filter material.

5. The method for manufacturing a filter unit according to claim 1, wherein
the filter portion and the first base portion are formed of a resin.
